(19) United States
(12) Patent Application Publication
(10) Pub. No.: US 2003/0075255 A1
(43) Pub. Date: Apr. 24, 2003

(54) Pneumatic vehicle tire

(76) Inventors: Marc-Andre Besson, Garbsen (DE); Jorg Burfien, Garbsen (DE); Hans Werner Gerke, Neustadt (DE); Andreas Hartwig, Garbsen (DE); Werner Holste, Hannover (DE); Dieter Jeromin, Hannover (DE); Norman Kaldune, Charlotte, NC (US); Michael Rosner, Seeize (DE); Wolfgang Rotter, Hannover (DE); Jorn Seevers, Burgdorf (DE); Ulrich Speckhals, Hannover (DE); Frank Weber, Neustadt (DE)

Correspondence Address: ROBERT W. BECKER & ASSOCIATES, Suite B., 707 Highway 66 East, Tijeras, NM, 87059, US

(21) Appl. No.: 10/279,203

(22) Filed: Oct. 23, 2002

(30) Foreign Application Priority Data
Oct. 23, 2001 (DE) 101 52 165.0-18

(51) Int. Cl. B60C 9/02; B60C 15/00; B60C 9/04; B60C 9/00; D07B 1/06

(52) U.S. Cl. 152/554; 152/548; 152/556; 152/451

(57) ABSTRACT

A pneumatic vehicle tire of radial construction, especially for automobiles, is provided. The tire has a profiled tread strip, a belt structure of at least two belt plies, bead regions having bead cores, and a carcass having load-carrying members of steel cord. In the tire the carcass forms a C-ply construction and contains steel cords of three or five steel filaments, which all have the same diameter of 0.12 to 0.1 5mm.

### BACKGROUND OF THE INVENTION

The present invention relates to a pneumatic vehicle tire of radial construction, especially for automobiles, and has a profiled tread strip, a belt structure having at least two belt plies, bead, regions with bead cores, and a carcass having load-carrying members of steel cord.

It has already been proposed, to dispose in the carcass ply or plies of the radial carcass of a pneumatic vehicle tire, load-carrying members of steel cord instead of the conventional load-carrying members of textile material. For example, reference is made to EP-A-0 849 098, where it is proposed to use steel cords, the filaments of which have a diameter between 0.1 mm and 0.45 mm, whereby the steel filaments are supposed to have a tensile strength of −2000×D+4400 MPa, where D is the filament diameter. A preferred range for the diameter of the steel filaments is between 0.14 and 0.42 mm. Pursuant to this reference, a number of different steel cord constructions are furthermore used, starting with constructions that have two filaments, up to constructions that have more than ten filaments. The preferred construction is a 1+5 construction. EP-A-0 987 128 also deals with the same subject matter, whereby here as the lower limit for the diameter of the steel filaments of the steel cord 0.07 mm is mentioned with the upper limit being 0.45 mm. The preferred range is between 0.07 and 0.12 mm. Here also the steel filaments can form a number of different steel cord constructions, as already mentioned. Both documents emphasize using a particularly high-strength steel, a so-called UHT (ultra high tensile) steel in order to be able to achieve a reduction in weight at high strength.

It is therefore an object of the present invention to provide a pneumatic vehicle tire having steel cords as the load-carrying members in the carcass, whereby the tire has a low weight yet is significantly improved with regard to its handling characteristics and its durability or service life.

### BRIEF DESCRIPTION OF THE DRAWINGS

This object, and other objects and advantages of the present invention, will appear more clearly from the following specification in conjunction with the accompanying schematic drawings, in which:

FIG. 1 is a cross-sectional view through one exemplary embodiment of an inventive pneumatic vehicle tire, and

FIGS. 2 and 3 are cross-sectional views through exemplary embodiments of inventive steel cords.

### SUMMARY OF THE INVENTION

The pneumatic vehicle tire of the present invention is characterized primarily in that the carcass forms a C-ply construction in the tire, and contains steel cords of three or five steel filaments, which for all steel filaments have the same diameter of 0.12 to 0.1 5 mm.

It has been shown that the inventive combination of a C-ply construction with steel cords as load-carrying members that have three or five filaments having a diameter of 0.12 to 0.15 mm significantly improves the handling characteristics and the durability of the tire. A steel cord that comprises three or five filaments, the diameter of which is in the range of between 0.12 and 0.15 mm, is optimally suited for use as a load-carrying member in the carcass of a tire due to its strength and flexibility. Tires embodied pursuant to the present invention demonstrate excellent handling characteristics, for example brief response times to steering forces, a markedly precise steering performance, a precise action when driving in curves, and a very stable behavior in the fringe range when driving in curves. Surprisingly, one can also achieve a significant reduction in the wear of the tread strip with the inventive tires in contrast to tires having a carcass with textile load-carrying members, such as load-carrying members of rayon. The C-ply construction contributes to an optimum introduction into the tire of the static and dynamic forces that occur during operation of the tire, whereby such forces can then be carried by the tire.

Pursuant to one preferred embodiment of the invention, the diameter of the filaments is 0.13 mm. Preferred constructions for the steel cord are 1×3 or 1×5 constructions. The steel used for the steel filaments is preferably a steel of the strength class SHT (super high tensile) having a tensile strength between 3350 and 3650 MPa. These embodiments have proven in tests to be particularly advantageous for the aforementioned tire characteristics, and therefore represent the optimum.

The carcass ply that with the C-ply construction extends laterally below the radially innermost belt ply of the belt construction should overlap with this belt ply by respectively at least 10 mm, and especially up to 30 mm.

The aforementioned object is further inventively realized where the steel cord in the carcass has either the 1×3 or the 1×5 construction and comprises steel filaments of the strength class SHT with a diameter of 0.1 3 mm.

It has been shown that the use of such steel cords in the carcass or in the carcass plies of an automobile tire is optimal with regard to strength and flexibility, whereby the flexibility is of great significance for the durability or service life of the tire. In this connection, a steel cord of the construction 5×0.13 appears even better than a steel cord of the construction 3×0.13 with regard to resistance to fatigue. Steel cords of both the 1×5 as well as the 1×3 constructions have shown themselves to be particularly advantageous with regard to their dynamic material characteristics. Steel cords having the same construction, but of individual filaments having a smaller diameter, have proven to be of unsatisfactory strength, while steel cords having steel filaments of greater diameter have shown themselves to be too stiff.

The advantages that can be achieved are independent of the structural design of the carcass, which can have a conventional configuration where the ends are looped about or that has a carcass ply that forms a C-ply construction. In this connection, improvements of the handling characteristics that can be achieved with inventively embodied tires are to a large extent independent of the configuration of the carcass. Whether a configuration having conventional looped-around ends or a C-ply construction is selected, in each case the aforementioned improvements, such as briefer response time to steering forces, very precise steering performance, precise behavior when driving in curves, as well as stable behavior in the fringe range when driving in a curve and an exact behavior when changing loads and tracks are observed.

In addition, the number of steel cords per decimeter in the carcass ply contributes to the optimization of the aforementioned characteristics. The number of steel cords should be between 90 and 160 per dm, especially between 100 and 135 per dm.

Further specific features of the present invention will be described in greater detail subsequently.

### DESCRIPTION OF PREFERRED EMBODIMENTS

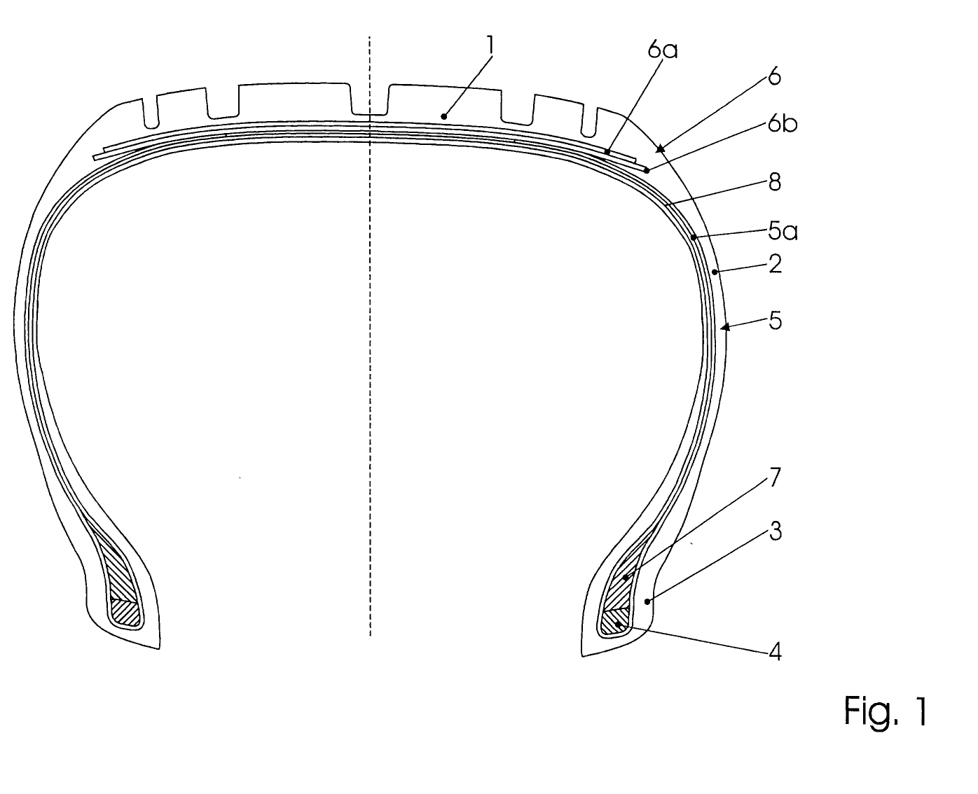

Referring now to the drawings in detail, the pneumatic vehicle tire shown in FIG. 1 is a radial automobile tire which, as its main components, is provided with a profiled tread strip 1, sidewalls 2, bead regions 3 having bead cores 4, a carcass 5, the configuration of which will be described in greater detail subsequently, a belt 6, filler or profiled core portions 7, and an inner liner 8, which is substantially airtight. In the illustrated embodiment, the belt 6 is comprised of two belt plies 6a, 6b, which have a conventional configuration and can therefore comprise, in particular, steel cords that are embedded in rubber and in each ply extend parallel to one another. In this connection, the steel cords within the belt ply 6a cross the steel cords that are disposed within the second belt ply 6b. In addition, the radially inwardly disposed belt ply 6b is wider than the upper belt ply 6a.

In the illustrated embodiment, the carcass 5 forms a so-called C-ply construction. In this connection, during build-up of the tire a single carcass ply 5a is applied in such a way that in the finished tire, in the sidewalls 2 the carcass ply 5a, accompanied by inclusion of the filler 7, extends about the bead cores 4 from the inside to the outside and is guided back up to beneath the belt 6 so that in the sidewalls 2 the ply 5a forms a double-ply carcass 5. The free ends extend to below the radially inner belt ply 6b and overlap the latter in a range of about 10 mm to 30 mm, especially 20 to 30 mm.

Certain advantages are associated with such an embodiment of the carcass 5. With a C-ply construction, the carcass ply 5a can be disposed in the tire in such a way that its load-carrying members extend in a radial direction or deviate from a precise radial direction at an angle that is of an order of magnitude of about 3 to 4°. Due to the looping-around in the bead region, and the guidance back to the belt 6, there results in the sidewalls 2 a crossed arrangement that is advantageous for the rigidity of the tire, namely a crossed arrangement of the load-carrying members in the two plies.

As a variation from the illustrated and particularly advantageous C-ply construction, the carcass can, in a conventional manner, also be provided with turned-up portions that end in the sidewalls.

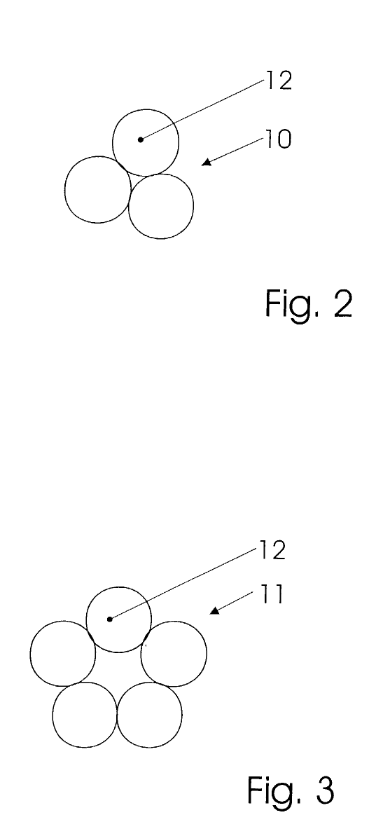

Pursuant to the present invention, independently of their configuration, the carcasses 5 contain, as load-carrying members, steel cords having a specific construction and configuration. Such a steel cord comprises either three or five filaments that are twisted with one another, in particular in the construction 1×3 or 1×5. FIG. 2 shows a cross-section through a steel cord 10 of 1×3 construction having three filaments 12; FIG. 3 shows a cross-section through a steel cord 11 of 1 ×5 construction having five filaments 12. The individual filaments 12 of the steel cords 10, 11 have a diameter that is between 0.12 mm and 0.15 mm. The preferred diameter of the filaments 12 is 0.13 mm. In this connection, the length of twist of a steel cord of 1×5 construction is between 4 and 8 mm, especially 5.5 mm, and the length of twist of a steel cord of 1×3 construction is between 3 and 7 mm, especially 4.5 mm. It has been shown that with tires, the carcass of which contains, as load-carrying members, such steel cords of 1×3 or 1×5 construction, which in addition belong to the strength class SHT, significant improvements of some tire characteristics can be achieved, especially with regard to the handling characteristics.

It is particularly advantageous if the number of steel cords 10, 11 in the carcass ply 5a are between 90 and 160 filaments/dm, especially between 100 and 135 filaments/dm.

It is also advantageous that tires having the inventively configured carcass have a lower weight than do tires having conventional carcasses with textile load-carrying members. Tires embodied pursuant to the present invention are furthermore characterized relative to conventional tires by an improvement of the so-called flat-spot property, whereby flat-spot denotes deformation of a resting tire that previously ran hot during operation. Furthermore, there surprisingly results a clear improvement in the operation of the tread strip and a reduction of non-uniform wear.

The steel filaments 12 of the steel cords 10, 11, as previously mentioned, preferably comprise steel of the strength class SHT (Super High Tensile), but it is also possible to use steel of the strength class UHT (Ultra High Tensile). Steel filaments of the strength class SHT have a tensile strength between 3350 and 3650 MPa, while steel filaments of the strength UHT have a tensile strength of greater than 3650 MPa.

The specification incorporates by reference the disclosure of German priority document 101 52 165.0-16 of Oct. 23, 2001.

The present invention is, of course, in no way restricted to the specific disclosure of the specification and drawings, but also encompasses any modifications within the scope of the appended claims.

What we claim is:

1. A pneumatic vehicle tire of radial construction, comprising:
a profiled tread strip;
a belt structure having at least two belt plies;
bead regions having bead cores; and
a carcass that in the tire forms a C-ply construction, wherein said carcass is provided with load-carrying members in the form of steel cords that each contain three or five steel filaments, wherein said filaments all have the same diameter of 0.12 to 0.15 mm.

2. A pneumatic vehicle tire according to claim 1, wherein said diameter of said steel filaments is 0.13 mm.

3. A pneumatic vehicle tire according to claim 1, wherein said steel cords have a 1×3 construction.

4. A pneumatic vehicle tire according to claim 3, wherein said steel cords have a twist length between 3 and 7 mm.

5. A pneumatic vehicle tire according to claim 1, wherein said steel cords have a 1×5 construction.

6. A pneumatic vehicle tire according to claim 5, wherein said steel cords have a twist length between 4 and 8 mm.

7. A pneumatic vehicle tire according to claim 1, wherein said steel filaments comprise a steel of the strength class SHT.

8. A pneumatic vehicle tire according to claim 1, wherein in a ply of said carcass the number of steel cords per dm is between 90 and 160.

9. A pneumatic vehicle tire according to claim 8, wherein the number of steel cords per dm is between 100 and 135.

10. A pneumatic vehicle tire according to claim 1, wherein regions of a ply of said carcass are guided-back and extend to below edge regions of a radially innermost one of said belt plies and overlap with the latter over a range of about 10 to 30 mm.

11. A pneumatic vehicle tire according to claim 10, wherein said overlap range is 20 to 30 mm.

12. A pneumatic vehicle tire of radial construction, comprising:
a profiled tread strip,
a belt structure having at least two belt plies,
bead regions having bead cores, and
an at least single-ply carcass that is provided with load-carrying members in the form of steel cords of 1×3 or 1×5 construction, wherein said steel cords comprise steel filaments of the strength class SHT, and wherein said filaments have a diameter of 0.13 mm.

13. A pneumatic vehicle tire according to claim 12, wherein in said carcass the number of steel cords per dm is between 90 and 160.

14. A pneumatic vehicle tire according to claim 13, wherein the number of steel cords per dm is between 100 and 135.

15. A pneumatic vehicle tire according to claim 12, wherein a ply or plies of said carcass are looped about said bead cores and back up.

16. A pneumatic vehicle tire according to claim 12, wherein a ply or plies of said carcass form a C-ply construction.

17. A pneumatic vehicle tire according to claim 16, wherein portions of a ply of said carcass are guided back to below edge regions of a radially innermost one of said belt plies and overlap with the latter over a range of about 10 to 30 mm.

18. A pneumatic vehicle tire according to claim 17, wherein said overlap range is 20 to 30 mm.

19. A pneumatic vehicle tire according to claim 12, wherein said steel cord has a 3×0.13 mm construction with a twist length between 3 and 7 mm.

20. A pneumatic vehicle tire according to claim 12, wherein said steel cord has a 5×0.13 mm construction with a twist length between 4 and 8 mm.
